(19) United States
(12) Patent Application Publication
(10) Pub. No.: US 2013/0094359 A1
(43) Pub. Date: Apr. 18, 2013

(54) APPARATUS AND METHOD FOR CONTROLLING QUALITY OF SERVICE OF WIRELESS NETWORK

(71) Applicant: Electronics and Telecommunications Research In, Daejeon (KR)

(72) Inventors: Kwi Hoon Kim, Daejeon (KR); Chung Hyun Ahn, Daejeon (KR); O Hyung Kwon, Daejeon (KR)

(73) Assignee: Electronics and Telecommunications Research Institute, Daejeon (KR)

(21) Appl. No.: 13/649,567

(22) Filed: Oct. 11, 2012

(30) Foreign Application Priority Data
Oct. 14, 2011 (KR) 10-2011-0105034
Feb. 24, 2012 (KR) 10-2012-0019311

(51) Int. Cl. H04W 28/12

(52) U.S. Cl. 370/231

(57) ABSTRACT

An apparatus and method for controlling quality of service (QoS) of a content provided to a mobile terminal in a wireless network are provided. The QoS control apparatus may include a content node search unit to search for a content node having optimized QoS for a mobile terminal when receiving a content request signal from the mobile terminal, and an information providing unit to provide information on the content node to the mobile terminal.

### CROSS-REFERENCE TO RELATED APPLICATIONS

This application claims the benefit of Korean Patent Application No. 10-2011-0105034 and of Korean Patent Application No. 10-2012-0019311, respectively filed on Oct. 14, 2011 and Feb. 24, 2012, in the Korean Intellectual Property Office, the disclosures of which are incorporated herein by reference.

### BACKGROUND

1. Field of the Invention

The present invention relates to an apparatus and method for controlling quality of a service of a content provided from a wireless network to a mobile terminal, and more particularly, to an apparatus and method for controlling quality of service (QoS) of a wireless network wireless network, the apparatus and method that provide a content with optimized QoS for a mobile terminal by searching for a content node to provide the content to the mobile terminal based on the QoS.

2. Description of the Related Art

Since January, 2009, Q.19 of the International Telecommunication Union-Telecommunication Standardization Sector (ITU-T) study group 13 (SG13) has been proceeding with standardization of distributed service networking (DSN) to provide the DSN. Recently, standardization in relation to functions of a DSN structure and a substructure is being actively developed.

The DSN provides a distributed service function in a peer-to-peer (P2P) form or mesh form to provide various multimedia services and applications. The DSN constructs an overlay network on the next-generation network (NGN) or legacy Internet having an administrative function. In the ITU-T NGN-global standards initiative (GSI) meeting of September, details of the functions of the DSN structure were collectively discussed and detailed standards related to the detailed functions were developed.

A conventional DSN-based network system is a technology for controlling quality of service (QoS) in a wired network. However, with an increase in distribution of smart devices, mobile terminals to be provided with a content through a wireless network are increasing.

Accordingly, there is a desire for a method of controlling QoS for a mobile terminal that makes wireless access.

### SUMMARY

An aspect of the present invention provides an apparatus and method that provide a content with quality of service (QoS) optimized for a mobile terminal by searching for a content node to provide the content to the mobile terminal.

Another aspect of the present invention provides an apparatus and method that provide a content with optimized QoS for a mobile terminal when the mobile terminal is moved.

Still another aspect of the present invention provides an apparatus and method that increase QoS when a plurality of mobile terminals request a same content.

According to an aspect of the present invention, there is provided a quality of service (QoS) control apparatus in a wireless network, including a content node search unit to search for a content node having optimized QoS for a mobile terminal when receiving a content request signal from the mobile terminal; and an information providing unit to provide information on the content node to the mobile terminal.

The content node search unit may search for the content node using wired network access information of the mobile terminal, wired network topology information adjacent to the mobile terminal, and traffic status information.

The content node search unit may search again for a content node when the mobile terminal is moved, using wireless network access information of the mobile terminal, wired network access information of the mobile terminal, wired network topology information adjacent to the mobile terminal, and traffic status information.

According to another aspect of the present invention, there is provided a wireless network system including a QoS control apparatus to provide information on a content node having optimized QoS for a mobile terminal when receiving a content request signal from the mobile terminal; and a resource admission control apparatus to reserve wired or wireless network resources between the mobile terminal and the content node.

The wireless network system may further include a network control apparatus to manage network access, the QoS control apparatus may search for the content using wired network access information of the mobile terminal, received from the network control apparatus, wired network topology information adjacent to the mobile terminal, received from the resource admission control apparatus, and traffic status information.

The wireless network system may further include at least one control node to transmit the content request signal received from the mobile terminal to the QoS control apparatus and, when the mobile terminal is moved, to stop the content node from providing a content to the mobile terminal.

The content node may provide a content to the mobile terminal that accessed according to the information on the content node, using the reserved network resources.

The wireless network system may further include a mobility management apparatus to manage information according to a movement of the mobile terminal, wherein the QoS control apparatus searches again for the content node using wireless network access information of the mobile terminal and wired network access information of the mobile terminal, received from the mobility management apparatus, wired network topology information adjacent to the mobile terminal, received from the resource admission control apparatus, and traffic status information.

The wireless network system may further include a mobile control node which accesses the content node according to the information on the content node when a plurality of mobile terminals transmit a content request signal with respect to a same content, and is provided with the content from the content node and multicasts the content to the plurality of mobile terminals.

According to another aspect of the present invention, there is provided a QoS control method in a wireless network, including searching for a content node having optimized QoS for a mobile terminal when receiving a content request signal from a mobile terminal; and providing information on the content node to the mobile terminal.

### EFFECT

According to embodiments of the present invention, a content node to provide a content to a mobile terminal is found using wired network access information of the mobile terminal, wired network topology information adjacent to the mobile terminal, and traffic status information. Accordingly, the content may be provided with quality of service (QoS) optimized for the mobile terminal.

Additionally, according to embodiments of the present invention, when the mobile terminal is moved, the content node to provide the content to the mobile terminal is found using wireless network access information of the mobile terminal, wired network access information of the mobile terminal, wired network topology information adjacent to the mobile terminal, and traffic status information. Accordingly, the content may be provided with optimized QoS for the moved mobile terminal.

In addition, according to embodiments of the present invention, when a plurality of mobile terminals request a same content, a base station is provided with the content by accessing the content node and provides the content to the plurality of mobile terminals. Consequently, the QoS may be increased.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a wireless network according to an embodiment of the present invention;

FIG. 2 is a block diagram illustrating a quality of service (QoS) control apparatus according to an embodiment of the present invention;

FIG. 3 is a diagram illustrating a process for a mobile terminal to be provided with a content in a wired or wireless network, according to the embodiment of the present invention;

FIG. 4 is a diagram illustrating a process for the mobile terminal to be provided with a content when the mobile terminal is moved, in a wired or wireless network, according to the embodiment of the present invention;

FIG. 5 is a diagram illustrating a process for a plurality of mobile terminals to be provided with a content, according to the embodiment of the present invention;

FIG. 6 is a flowchart illustrating a QoS control method of a wireless network, according to the embodiment of the present invention;

FIG. 7 is a flowchart illustrating a method for a mobile terminal to be provided with a content when the mobile terminal is moved, in a wired or wireless network, according to the embodiment of the present invention; and

FIG. 8 is a flowchart illustrating a method for a plurality of mobile terminals to be provided with a content in a wired or wireless network, according to the embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. A quality of service (QoS) control method of a wireless network according to an embodiment of the present invention may be performed by a QoS control apparatus of a wireless network.

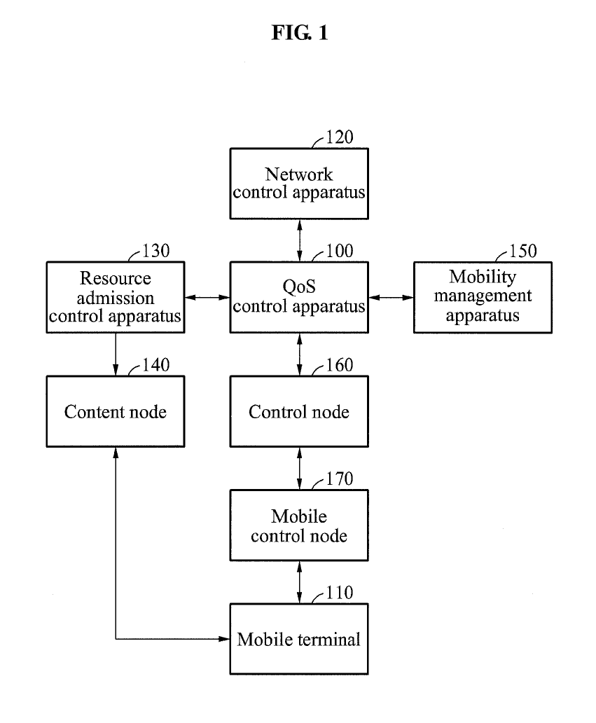

FIG. 1 is a diagram illustrating a wireless network according to an embodiment of the present invention.

As shown in FIG. 1, the wireless network may include a QoS control apparatus 100, a network control apparatus 120, a resource admission control apparatus 130, a content node 140, a mobility management apparatus 150, a control node 160, and a mobile control node 170.

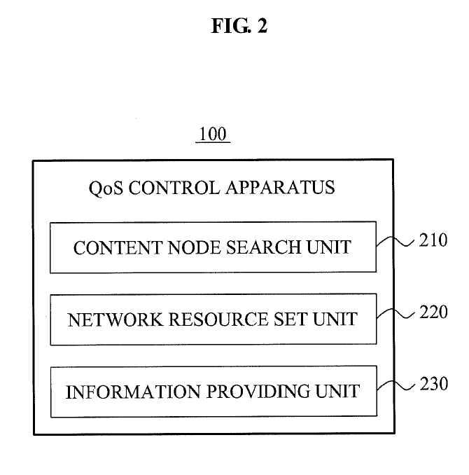

When providing a distributed service networking (DSN)-based service in a wireless environment using a mobile terminal 110, the QoS control apparatus 100 may select the content node 140 capable of providing an optimized quality of service (QoS) and provide information on the content node 140 to the mobile terminal 110. A detailed structure of the QoS control apparatus 100 will be described in detail with reference to FIG. 2.

The network control content 120 may manage access of the wireless network by a network attachment control function (NACF). Here, the network control apparatus 120 may generate wired network access information based on an access location of the mobile terminal 110, an internet protocol (IP), and user preference with respect to the mobile terminal 110, and may provide the wired network access information according to a request by the QoS control apparatus 100.

The resource admission control apparatus 130 may control QoS of the wireless network by a resource admission and control function (RACF). Here, the resource admission control apparatus 130 may manage wired network topology information adjacent to the mobile terminal 110 and traffic status information and provide the wired network topology information and the traffic status information according to the QoS control apparatus 100.

The resource admission control apparatus 130 may reserve wired or wireless network resources between the mobile terminal 110 and the content node 140 selected by the QoS control apparatus 100, according to the request by the QoS control apparatus 100. Accordingly, when the mobile terminal 110 is provided with a content, the QoS may be increased.

The content node 140 may store a content and provide the content to the mobile terminal 110 that accessed according to the information on the content node 140 received from the QoS control apparatus 100.

That is, the content node 140 may provide the content to the mobile terminal 110 using the wired or wireless network resources reserved by the resource permission control apparatus 130.

In addition, a plurality of the content nodes 140 providing a same content may be provided. The plurality of content nodes 140 may provide the content to the mobile terminal 110 with different QoS according to the location of the mobile terminal 110 or topology or traffic of a network located between the mobile terminal 110 and the content node 140.

For example, a content node accessed by less users may provide the content with higher QoS than a content accessed by more users.

The mobility management apparatus 150 may manage and control mobility of the wireless network by a mobility management and control function (MMCF). The mobility management apparatus 150 may manage wireless network access information of the mobile terminal 110. The wireless network access information may include at least one of an access type, attachment information, L1/L2 address, and support bitrates.

When the mobile terminal 110 is moved, the mobility management apparatus 150 may receive the wired network access information from the network control apparatus 120 and provide the received wired network access information and the wireless network access information together according to the request by the QoS control apparatus 100. That is, structures for transmitting network access information to the QoS control apparatus 100 may be unified.

The control node 160 may include at least one relay node that transmits the content request signal received from the mobile terminal 110 to the QoS control apparatus 100. In addition, when the mobile terminal 110 is moved, the content node 160 may transmit a content transmission stop signal to the content node 140 which is providing the content to the mobile terminal 110.

The mobile control node 170 may be connected with the mobile terminal 110 wirelessly, thereby relaying the content request signal, content node information, and the content. In addition, when a plurality of mobile terminals 110 are provided with a same content, the mobile control node 170 may multicast the content provided from the content node 140 to the plurality of mobile terminals 110. In this case, the mobile control node 140 may be a base station.

In detail, when the plurality of mobile terminals 110 each transmit a content request signal with respect to the same content, the mobile control node 170 may receive the information on the content node 140 from the QoS control apparatus 100 according to the content request signals. Next, the mobile control node 170 may access the content node 140 according to the information on the content node 140 and may be provided with the content from the content node 140 and multicast the content to the plurality of mobile terminals 110.

FIG. 2 is a block diagram illustrating the QoS control apparatus 100 according to an embodiment of the present invention.

Referring to FIG. 2, the QoS control apparatus 100 may include a content node search unit 210, a network resource set unit 220, and an information providing unit 230.

When receiving a content request signal from the mobile terminal 110, the content node search unit 210 may search for the content node 140 having optimized QoS for the mobile terminal 110.

The content node search unit 210 may search for the content node 140 using wired network access information of the mobile terminal 110, which is received from the network control apparatus 120, wired network topology information adjacent to the mobile terminal 110, which is received from the resource permission control apparatus 130, and traffic status information.

In detail, the content node search unit 210 may search for a content node 140 capable of providing a content corresponding to the content request signal. When a plurality of content nodes 140 are found, the content node search unit 210 may search for a content node having optimized QoS for the mobile terminal 110, using the wired network access information of the mobile terminal 110, the wired network topology information adjacent to the mobile terminal 110, and the traffic status information.

When location of the mobile terminal 110 is changed, the content node search unit 210 may search for a content node again using the wireless network access information and wired network access information of the mobile terminal 110, which is received from the mobility management apparatus 150, the wired network topology information adjacent to the mobile terminal 110, which is received from the resource permission control apparatus 130, and the traffic status information.

The network resource set unit 220 may set wired or wireless network resources between the mobile terminal 110 and the content node found by the content node search unit 210.

In detail, when the content node search unit 210 searches for the content node 140 having the optimized QoS, the network resource set unit 220 may transmit a signal to the resource admission control apparatus 130 to request reservation of the wired or wireless network resources between the corresponding content node 140 and the mobile terminal 110, thereby setting the wired or wireless network resources between the mobile terminal 110 and the content node 140.

The information providing unit 230 may provide the information on the content node 140 found by the content node search unit 210.

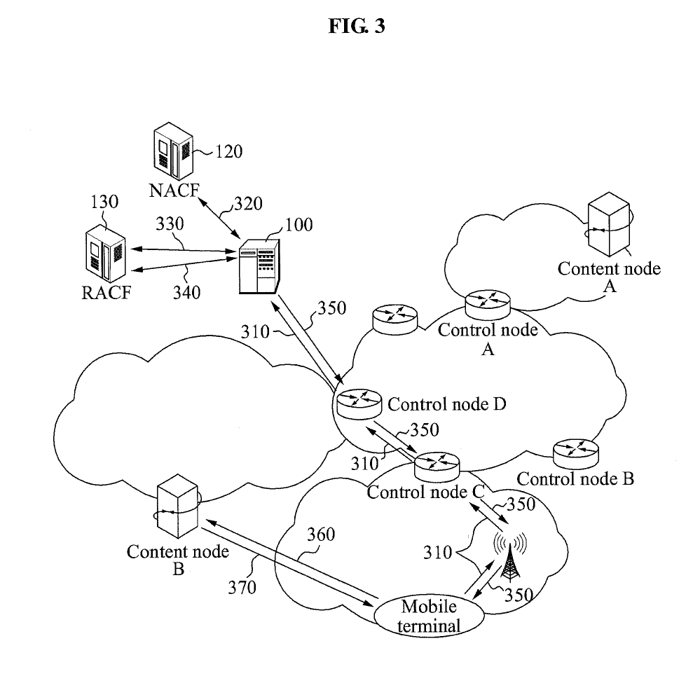

FIG. 3 is a diagram illustrating a process for the mobile terminal 110 to be provided with a content in a wired or wireless network, according to an embodiment of the present invention.

The mobile terminal 110 may transmit a content request signal requesting a content selected by a user. Here, the content request signal may be transmitted to a QoS control apparatus 100 through control nodes in operation 310.

When receiving the content request signal, the QoS control apparatus 100 may request the network control apparatus 120 for wired network access information of the mobile terminal 110 and receive the wired network access information of the mobile terminal 110 transmitted according to the request, in operation 320.

When receiving the content request signal, the QoS control apparatus 100 may request the resource admission control apparatus 130 for wired network topology information adjacent to the mobile terminal 110 and traffic status information, and receive the wired network topology information and the traffic status information transmitted according to the request, in operation 330.

Next, the QoS control apparatus 100 may search for a content node 140 capable of providing a content corresponding to the content request signal. When a plurality of content nodes 140 are found, the QoS control apparatus 100 may search for a content node B having optimized QoS for the mobile terminal 110, using the wired network access information of the mobile terminal 110, the wired network topology information adjacent to the mobile terminal 110, and the traffic status information.

Here, the QoS control apparatus 100 may transmit a signal to the resource admission control apparatus 130 to request reservation of wired or wireless network resources between the content node B and the mobile terminal 110, in operation 340.

Next, the QoS control apparatus 100 may transmit information on the content node B to the mobile terminal 110 through the control nodes, in operation 350.

Next, the mobile terminal 110 may access the content node B according to the information on the content node B, in operation 360.

At last, in operation 370, the content node B may provide the content to the mobile terminal 110 using the wired or wireless network resources reserved by the resource admission control apparatus 130. Accordingly, the content may be provided with high QoS.

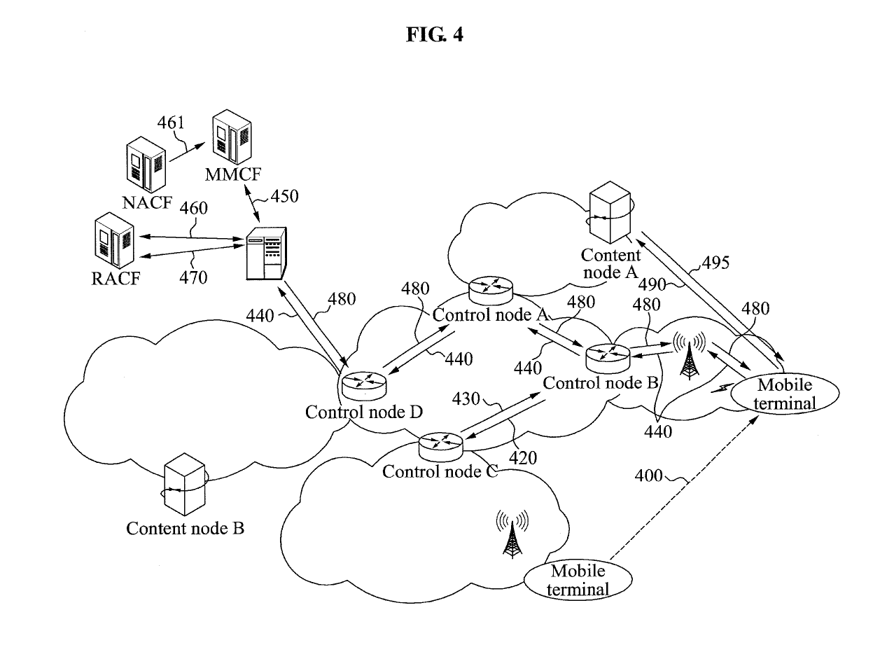

FIG. 4 is a diagram illustrating a process for the mobile terminal 110 to be provided with a content when the mobile terminal 110 is moved, in a wired or wireless network, according to the embodiment of the present invention.

According to the embodiment of FIG. 4, when the mobile terminal 110 is moved while being provided with the content according to the embodiment of FIG. 3 in operation 400, a content is provided with high QoS according to a moved location of the mobile terminal 110.

As shown in FIG. 4, when the mobile terminal 110 is moved while being provided with the content in operation 400, the mobile terminal 110 may retransmit a content request signal in operation 410. Also, when the mobile terminal 110 is moved, the mobility management apparatus 150 may receive wired network access information from the network control apparatus 120 in operation 401.

Here, in operation 420, the control node B receiving the content request signal may request a control node C for profile information of the content being provided to the mobile terminal 110.

The control node C may transmit the profile information to the control node B according to the request in operation 430. In this operation, the control node C may transmit a content transmission stop signal to the content node B providing the content to the user, thereby preventing the content node B, of which QoS is reduced due to the movement of the mobile terminal 110, from providing the content to the mobile terminal 110.

Next, the control node B may transmit the content request signal received from the mobile terminal 110 to the QoS control apparatus 100 through other control nodes in operation 440.

When receiving the content request signal again, the QoS control apparatus 100 may request the mobility management apparatus 150 for the wired network access information and the wireless network access information of the mobile terminal 110 and receive the wired network access information and the wireless channel access information transmitted according to the request, in operation 450.

When receiving the content request signal again, the QoS control apparatus 100 may request the resource admission control apparatus 130 for the wired network topology information adjacent to the mobile terminal 110 and the traffic status information, and receive the wired network topology information and the traffic status information transmitted according to the request in operation 460.

Next, the QoS control apparatus 100 may search for the content node 140 capable of providing the content corresponding to the content request signal. When a plurality of content nodes 140 are found, the QoS control apparatus 100 may search for a content node A having optimized QoS for the mobile terminal 110, using the wired network access information of the mobile terminal 110, the wireless network access information, the wired network topology information adjacent to the mobile terminal 110, and the traffic status information.

Here, the QoS control apparatus 100 may transmit a signal requesting reservation of the wired or wireless network resources between the content node A and the mobile terminal 110, in operation 470.

Next, the QoS control apparatus 100 may transmit information on the content node A through the control nodes, in operation 480.

Next, the mobile terminal 110 receiving the information on the content node A may access the content node A according to the information on the content node A, in operation 490.

At last, the content node A may provide the content to the mobile terminal 110 using the wired or wireless network resources reserved by the resource admission control apparatus 130, in operation 495. Thus, the content node A may provide the content with high QoS. Here, the content node A may check a part of the content provided to the mobile terminal 110, using the profile information, and subsequently transmit a next part of the part transmitted to the mobile terminal 110.

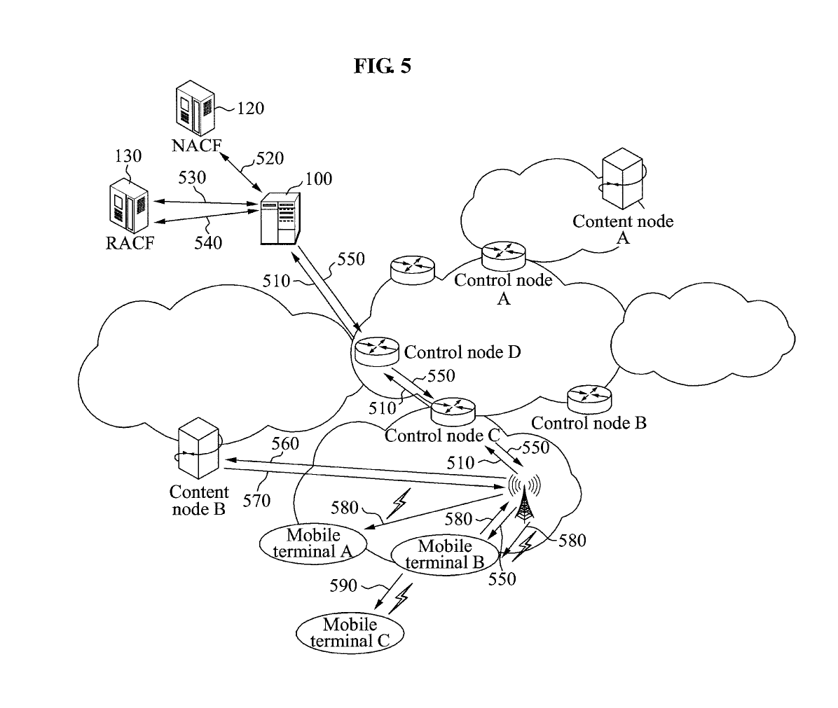

FIG. 5 is a diagram illustrating a process for a plurality of the mobile terminals 110 to be provided with a content, according to the embodiment of the present invention.

That is, FIG. 5 shows a process of providing a content to the plurality of mobile terminals 110 when the plurality of mobile terminals 110 are provided with the same content.

In operation 510, the mobile control node 170 may receive content request signals transmitted by the plurality of mobile terminals 110 and transmit the content request signals to the QoS control apparatus 100 through the control nodes.

In operation 520, when receiving the content request signals, the QoS control apparatus 100 may request the network control apparatus 120 for wired network access information of the mobile terminal 110 and receive the wired network access information transmitted according to the request.

In operation 530, when receiving the content request signals, the QoS control apparatus 100 may request the resource admission control apparatus 130 for the wired network topology information adjacent to the mobile terminal 110 and the traffic status information, and receive the wired network topology information and the traffic status information transmitted according to the request.

Next, the QoS control apparatus 100 may search for a content node 140 capable of providing a content corresponding to the content request signal. When a plurality of content nodes 140 are found, the QoS control apparatus 100 may search for a content node B having optimized QoS for the mobile terminal 110, using the wired network access information of the mobile terminal 110, the wired network topology information adjacent to the mobile terminal 110, and the traffic status information.

Here, in operation 540, the QoS control apparatus 100 may transmit a signal to the resource admission control apparatus 130 to request reservation of the wired or wireless network resources between the content node B and the mobile terminal 110.

Next, in operation 550, the QoS control apparatus 100 may transmit information on the content node B to the mobile terminal 110 through the control nodes and the mobile control node 170.

In this instance, in operation 560, the mobile control node 170 may access the content node B according to the information on the content node B.

Next, in operation 570, the mobile control node 170 may be provided with the content from the content node B using the wired or wireless network resources reserved by the resource admission control apparatus 130.

At last, in operation 580, the mobile control node 170 may multicast the provided content to the plurality of mobile terminals 110. With respect to a mobile terminal located beyond a range of multicasting, for example a mobile terminal C, the mobile control node 170 may provide the content by controlling a mobile terminal that received the content by multicast, for example a mobile terminal B, to relay the content, in operation 590.

That is, when the plurality of mobile terminals 110 request the same content, the QoS control method according to the embodiment of the present invention may multicast the content by the mobile control node 170, thereby providing the content with high QoS.

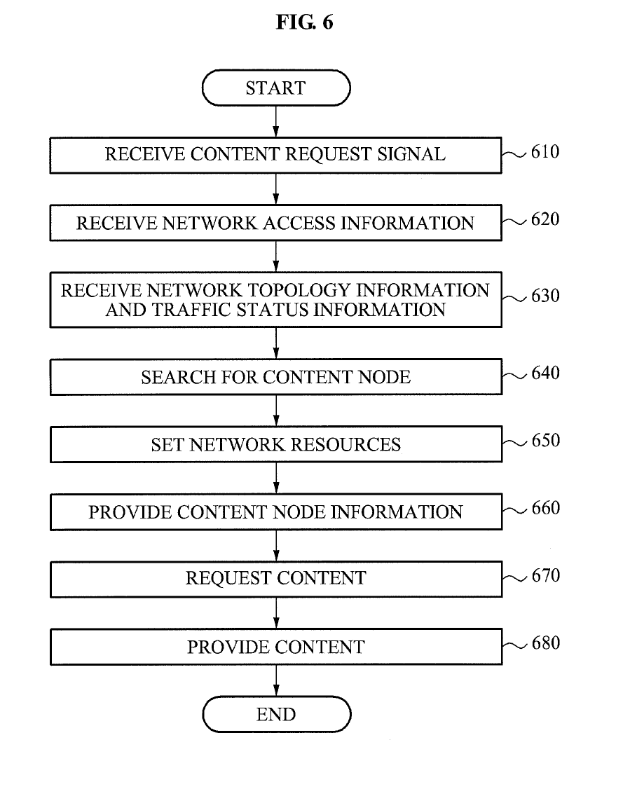

FIG. 6 is a flowchart illustrating a QoS control method of a wireless network, according to the embodiment of the present invention.

In operation 610, the QoS control apparatus 100 may receive a content request signal transmitted from the mobile terminal 110 through the control nodes.

In operation 620, the QoS control apparatus 100 may request the network control apparatus 120 for the wired network access information of the mobile terminal 110 according to the content request signal transmitted in operation 610, and may receive the wired network access information of the mobile terminal 110 transmitted according to the request.

In operation 630, the QoS control apparatus 100 may request the resource admission control apparatus 130 for the wired network topology information adjacent to the mobile terminal 110 and the traffic status information according to the content request signal received in operation 610, and may receive the wired network topology information and the traffic status information transmitted according to the request.

In operation 640, the QoS control apparatus 100 may search for a content node 140 capable of providing the content corresponding to the content request signal received in operation 610. When a plurality of content nodes 140 are found, the QoS control apparatus 100 may search for a content node having optimized QoS for the mobile terminal 110, using the wired network access information of the mobile terminal 110, which is received in operation 620, and the wired network topology information adjacent to the mobile terminal 110 and the traffic status information, which are received in operation 630.

In operation 650, the QoS control apparatus 100 may transmit a signal to the resource admission control apparatus 130 to request reservation of the wired or wireless network resources between the content node found in operation 640 and the mobile terminal 110, thereby setting the wired or wireless network resources between the content node and the mobile terminal 110.

In operation 660, the QoS control apparatus 100 may transmit information on the content node found in operation 640 to the mobile terminal 110, through the control nodes.

In operation 670, the mobile terminal 110 may access the content node according to the information on the content node received in operation 660, and request the content.

In operation 680, the content node may provide the content to the mobile terminal 110 that made an access in operation 670, using the wired or wireless network resources reserved by the resource admission control apparatus 130 in operation 650.

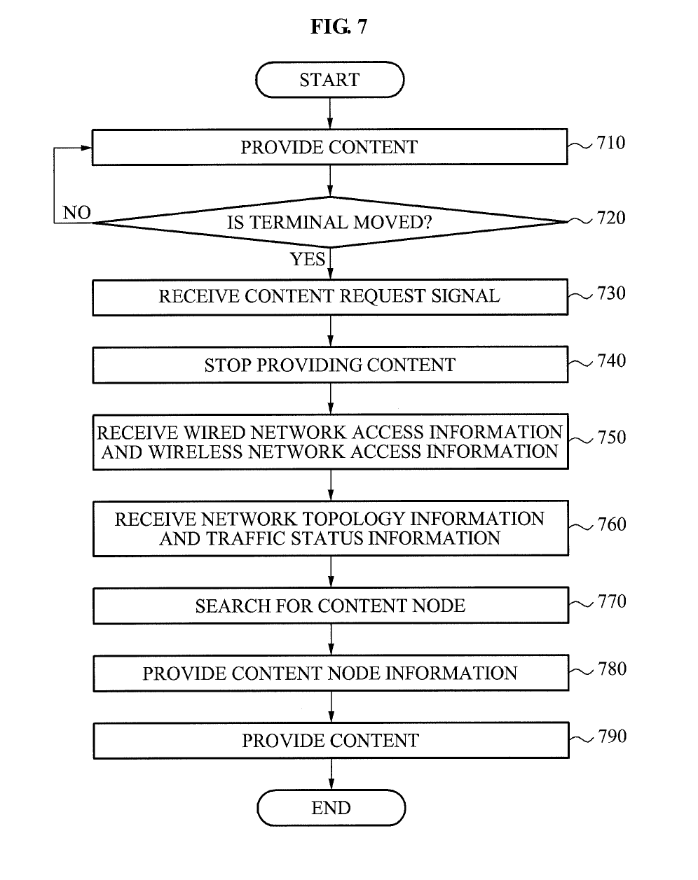

FIG. 7 is a flowchart illustrating a method for a mobile terminal to be provided with a content when the mobile terminal is moved, in a wired or wireless network, according to the embodiment of the present invention.

That is, FIG. 7 is a flowchart illustrating a method for providing a content with high QoS according to location of the mobile terminal 110 when the mobile terminal 110 is moved while being provided with the content in operation 680.

In operation 710, the mobile terminal 110 may be provided with a content node B. Operation 710 may be the same as operation 680 of FIG. 6.

In operation 720, the mobility management apparatus 150 may check whether the mobile terminal 110 is moved. When the mobile terminal 110 is moved, the mobility management apparatus 150 may receive the wired network access information from the network control apparatus 120. Furthermore, the mobile terminal 110 may retransmit a content request signal during the movement.

In operation 730, the control node 160 may receive the content request signal retransmitted by the mobile terminal 110 in operation 720.

In operation 740, the control node 160 may transmit a content transmission stop signal to the content node, thereby preventing the content node of which QoS is reduced due to the movement of the mobile terminal 110 from providing the content to the mobile terminal 110. In addition, the control node 160 may transmit the content request signal received from the mobile terminal 110 to the QoS control apparatus 100.

In operation 750, the QoS control apparatus 100 may request the mobility management apparatus 150 for the wired network access information and the wireless network access information of the mobile terminal 110 according to the content request signal retransmitted in operation 740. Also, the QoS control apparatus 100 may receive the wired network access information and the wireless network access information of the mobile terminal 110 transmitted according to the request.

In operation 760, the QoS control apparatus 100 may request the resource admission control apparatus 130 for the wired network topology information adjacent to the mobile terminal 110 and the traffic status information, according to the content request signal received again in operation 740. Also, the QoS control apparatus 100 may receive the wired network topology information and the traffic status information transmitted according to the request.

In operation 770, the QoS control apparatus 100 may search for a content node 140 capable of providing a content corresponding to the content request signal received again in operation 740. When a plurality of content nodes 140 are found, the QoS control apparatus 100 may search again for a content having optimized QoS for the mobile terminal 110, using the wired network access information and the wireless network access information of the mobile terminal 110, which are received in operation 750, and the wired network topology information adjacent to the mobile terminal 110 and the traffic status information, which are received in operation 760.

Here, the QoS control apparatus 100 may transmit a signal to the resource admission control apparatus 130 to request reservation of the wired or wireless network resources between the content node and the mobile terminal 110.

In operation 780, the QoS control apparatus 100 may transmit information on the content node to the mobile terminal 110 through the control nodes.

In operation 790, the mobile terminal 110 receiving the information on the content node may access the content node according to the information on the content node. The content node may provide the content to the mobile terminal 110 using the wired or wireless network resources reserved by the resource admission control apparatus 130, thereby providing the content with high QoS. Here, the content node may check a part of the content provided to the mobile terminal 110, using the profile information, and subsequently transmit a next part of the part transmitted to the mobile terminal 110.

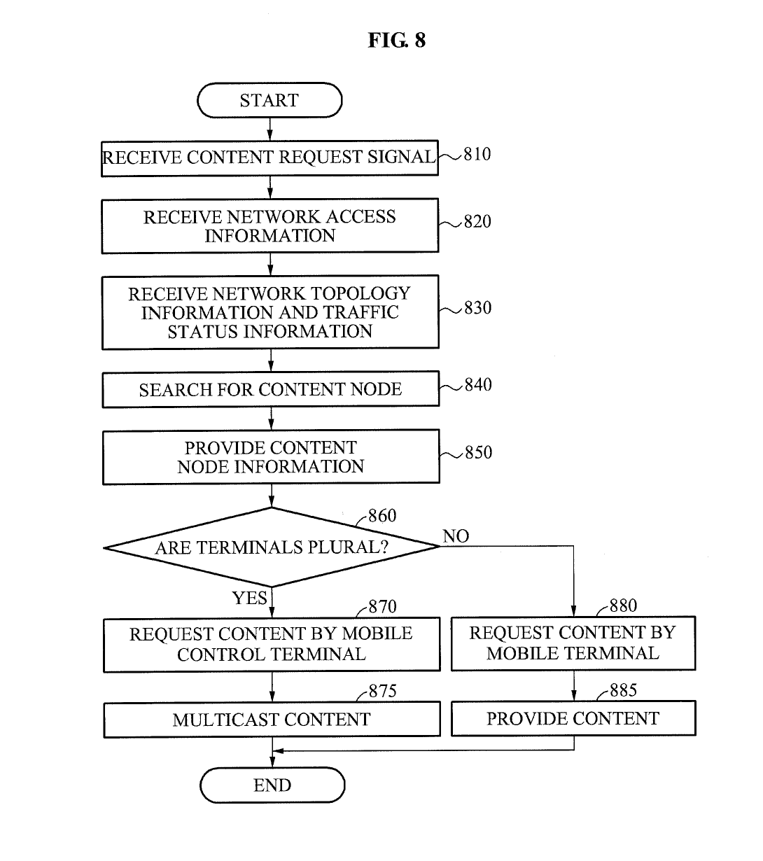

FIG. 8 is a flowchart illustrating a method for a plurality of mobile terminals to be provided with a content in a wired or wireless network, according to the embodiment of the present invention.

In operation 810, the QoS control 100 may receive a content request signal transmitted from the mobile terminal 110 through the mobile control node 170 and the control nodes.

In operation 820, the QoS control apparatus 100 may request the network control apparatus 120 for the wired network access information of the mobile terminal 110 according to the content request signal received in operation 810, and receive the wired network access information of the mobile terminal 110 transmitted according to the request.

In operation 830, the QoS control apparatus 100 may request the resource admission control apparatus 130 for the wired network topology information adjacent to the mobile terminal 110 and the traffic status information according to the content request signal received in operation 810, and receive the foregoing information transmitted according to the request.

In operation 840, the QoS control apparatus 100 may search for a content node 140 capable of providing a content corresponding to the content request signal received in operation 810. When a plurality of content nodes 140 are found, the QoS control apparatus 100 may search for a content node having optimized QoS for the mobile terminal 110, using the wired network access information of the mobile terminal 110 which is received in operation 820, and the wired network topology information adjacent to the mobile terminal 110 and the traffic status information which are received in operation 830.

Here, the QoS control apparatus 100 may transmit a signal to the resource admission control apparatus 130 to request reservation of the wired or wireless network resources between the content node found in operation 840 and the mobile terminal 110, thereby setting the wired or wireless network resources between the content node and the mobile terminal 110.

Next, in operation 850, the QoS control apparatus 100 may transmit information on the content node found in operation 840 to the mobile terminal 110 through the control nodes and the mobile control node 170.

In operation 860, the mobile control node 170 may check whether the mobile terminal 110 transmitting the same content request signal is plural in number.

The mobile control node 170, confirming that a plurality of the mobile terminals 110 transmit the same content request signals in operation 860, may access the content node according to the information on the content node while the information on the content node is being relayed to the mobile terminal 110 in operation 850. Next, the mobile control node 170 may be provided with the content from the content node using the wired or wireless network resources reserved by the resource admission control apparatus 130.

In operation 875, the mobile control node 170 may wirelessly multicast the content provided in operation 870 to the plurality of mobile terminals 110. Here, with respect to a mobile terminal located beyond a range of multicasting, the mobile control node 170 may provide the content by controlling a mobile terminal that received the content by multicast to relay the content.

In operation 880, the plurality of mobile terminals 110 may access the content node according to the information on the content node received in operation 850 and request the content.

In operation 885, the content node may provide the content to the mobile terminal 110 that accessed in operation 880 using the wired or wireless network resources reserved by the resource admission control apparatus 130. Thus, the content may be provided with high QoS.

According to the embodiments of the present invention, a content node to provide a content to a mobile terminal is found using wired network access information of the mobile terminal, wired network topology information adjacent to the mobile terminal, and traffic status information. Accordingly, the content may be provided with high QoS optimized for the mobile terminal.

When the mobile terminal is moved, the content node to provide the content to the mobile terminal is found using wireless network access information of the mobile terminal, wired network access information of the mobile terminal, wired network topology information adjacent to the mobile terminal, and traffic status information. Accordingly, the content may be provided with optimized QoS for the moved mobile terminal.

In addition, when a plurality of mobile terminals request a same content, a base station is provided with the content by accessing the content node and provides the content to the plurality of mobile terminals. Consequently, the QoS may be increased.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A quality of service (QoS) control apparatus in a wireless network, the apparatus comprising:
a content node search unit to search for a content node having optimized QoS for a mobile terminal when receiving a content request signal from the mobile terminal; and
an information providing unit to provide information on the content node to the mobile terminal.

2. The QoS control apparatus of claim 1, wherein the content node search unit searches for the content node using wired network access information of the mobile terminal, wired network topology information adjacent to the mobile terminal, and traffic status information.

3. The QoS control apparatus of claim 1, wherein the content search unit searches for the content node having optimized QoS for the mobile terminal among a plurality of contents nodes which provide a content corresponding to the content request signal.

4. The QoS control apparatus of claim 1, further comprising:
a network resource set unit to set wired or wireless network resources between the mobile terminal and the content node,
wherein the mobile terminal receives a content from the content node using the wired or wireless network resources.

5. The QoS control apparatus of claim 1, wherein the content node search unit searches again for a content node when the mobile terminal is moved, using wireless network access information of the mobile terminal, wired network access information of the mobile terminal, wired network topology information adjacent to the mobile terminal, and traffic status information.

6. A wireless network system comprising:
a quality of service (QoS) control apparatus to provide information on a content node having optimized QoS for a mobile terminal when receiving a content request signal from the mobile terminal; and
a resource admission control apparatus to reserve wired or wireless network resources between the mobile terminal and the content node.

7. The wireless network system of claim 6, further comprising a network control apparatus to manage network access,
wherein the QoS control apparatus searches for the content using wired network access information of the mobile terminal, received from the network control apparatus, wired network topology information adjacent to the mobile terminal, received from the resource admission control apparatus, and traffic status information.

8. The wireless network system of claim 6, further comprising:
at least one control node to transmit the content request signal received from the mobile terminal to the QoS control apparatus and, when the mobile terminal is moved, to stop the content node from providing a content to the mobile terminal.

9. The wireless network system of claim 6, wherein the content node provides a content to the mobile terminal that accessed according to the information on the content node, using the reserved network resources.

10. The wireless network system of claim 6, further comprising a mobility management apparatus to manage information according to a movement of the mobile terminal,
wherein the QoS control apparatus searches again for the content node using wireless network access information of the mobile terminal and wired network access information of the mobile terminal, received from the mobility management apparatus, wired network topology information adjacent to the mobile terminal, received from the resource admission control apparatus, and traffic status information.

11. The wireless network system of claim 10, wherein
the resource admission control apparatus reserves wired or wireless network resources between the mobile terminal and the content node, and
the mobile terminal accesses the content node and is provided with the content using the reserved wired or wireless network resources.

12. The wireless network system of claim 6, further comprising a mobile control node which accesses the content node according to the information on the content node when a plurality of mobile terminals transmit a content request signal with respect to a same content, and is provided with the content from the content node and multicasts the content to the plurality of mobile terminals.

13. A quality of service (QoS) control method in a wireless network, the method comprising:
searching for a content node having optimized QoS for a mobile terminal when receiving a content request signal from a mobile terminal; and
providing information on the content node to the mobile terminal.

14. The QoS control method of claim 13, wherein the searching comprises searching for the content node using wired network access information of the mobile terminal, wired network topology information adjacent to the mobile terminal, and traffic status information.

15. The QoS control method thod of claim 13, wherein the searching comprises searching for the content node having the optimized QoS for the mobile terminal among a plurality of content nodes that provide a content corresponding to the content request signal.

16. The QoS control method thod of claim 13, further comprising:
setting wired or wireless network resources between the mobile terminal and the content node,
wherein the mobile terminal receives a content from the content node using the wired or wireless network resources.

17. The QoS control method thod of claim 13, further comprising:
searching again for a content node when the mobile terminal is moved, using wireless network access information of the mobile terminal, wired network access information of the mobile terminal, wired network topology information adjacent to the mobile terminal, and traffic status information.
